(19) United States
(12) Patent Application Publication
(10) Pub. No.: US 2018/0245598 A1
(43) Pub. Date: Aug. 30, 2018

(54) Turbo Fan

(71) Applicant: Micronel AG, Tagelswangen (CH)

(72) Inventors: Peter Meier, Fehraltorf (CH); Dieter Albisser, Lengnau (CH)

(21) Appl. No.: 15/758,103

(22) PCT Filed: Aug. 16, 2016
(86) PCT No.: PCT/EP2016/069414

§ 371 Date: Mar. 7, 2018

(30) Foreign Application Priority Data
Sep. 8, 2015 (EP) 15184175.6

(51) Int. Cl. F04D 25/08; F04D 25/06; F04D 29/42; F04D 29/44; F04D 29/58; H02K 5/20; H02K 7/14; H02K 9/14

(52) U.S. Cl. CPC F04D 25/082; F04D 25/06; F04D 29/4253; H02K 9/14; F04D 29/5806; H02K 5/20; H02K 7/14; F04D 29/444

(57) ABSTRACT

A fan has a motor, a fan impeller, a cooling body and a housing. The motor is electrically driven and has a stator and has a rotor which is mounted so as to be rotatable about an axis of rotation, wherein the motor has at least one winding through which an electrical current flows during operation. The fan impeller is fastened rotationally conjointly to the rotor and serves for drawing in and conveying a gaseous medium. The cooling body has an inner wall which delimits an interior space for accommodating the motor, and has air-guiding elements which extend in each case in an axial direction over a major part of the longitudinal extent of the winding, through which electrical current flows, in order to conduct the gaseous medium, which is conveyed by the fan impeller, along the cooling body for motor cooling purposes. The housing has an outer wall which delimits a cavity for accommodating the cooling body and the motor.

### TECHNICAL FIELD

The present invention relates to a fan having a fan impeller for drawing in and conveying a gaseous medium. The fan may serve for example for air extraction, for generating an air flow and/or for generating a positive pressure and/or a negative pressure of air or of some other gaseous medium.

### PRIOR ART

Fans, which in particular also include ventilators, blowers and compressors, have long been known and are used in a wide variety of applications. Fans have a commonly electrically driven fan impeller which rotates in a housing and thereby conveys and compresses a gaseous medium, such as in particular air.

In the case of fans, aside from the aerodynamic values, it is the case in particular that the fan volume, the overall weight, the vibration characteristics and the resulting acoustics play an important role. In particular, adequate cooling of the electric motor plays a central role in the design of electrically driven fans.

DE 10 2013 102 755 A1 discloses a blower in the case of which the air that is drawn in by a fan impeller is conducted by way of a diffuser through a motor housing in order to cool the electric motor arranged therein.

In the case of the fan presented in WO 97/30621, the air that is drawn in is, for motor cooling purposes, conducted both through the motor housing and along the outer side of the motor housing.

DE 10 2013 104 849 A1 presents a fan in which the air that is conveyed by a fan impeller is conducted by way of guide blades along an inner wall which surrounds the motor. The inner wall has apertures such that the air can pass to the motor and cool the latter.

By virtue of the fact that, in the case of each of the fans which are disclosed in the above-cited prior art documents, the air that is conveyed by the fan impeller flows directly along the electric motor, efficient motor cooling can be achieved. However, the air is in each case highly turbulent as it flows along the motor, which not only yields an impairment of the aerodynamics of the fan but also leads to intensified vibrations and noise.

### PRESENTATION OF THE INVENTION

It is thus an object of the present invention to specify a powerful fan with an efficient motor cooling arrangement, which fan furthermore exhibits as little noise and vibrations as possible and has a simple construction. To achieve said object, a fan as specified in claim 1 is proposed. The dependent claims specify advantageous refinements of the invention.

The present invention thus provides a fan, comprising
an electrically driven motor having a stator and having a rotor which is mounted so as to be rotatable about an axis of rotation, wherein a radial and an axial direction of the fan are defined on the basis of the axis of rotation, and wherein the motor has at least one winding through which an electrical current flows during operation;
a fan impeller which is fastened rotationally conjointly to the rotor and which serves for drawing in and conveying a gaseous medium;
a cooling body having an inner wall which delimits an interior space for accommodating the motor, and having air-guiding elements which extend in each case in the axial direction over a major part of the longitudinal extent of the winding, through which electrical current flows, in order to conduct the gaseous medium, which is conveyed by the fan impeller, along the cooling body for motor cooling purposes; and
a housing having an outer wall which delimits a cavity for accommodating the cooling body and the motor.

The gaseous medium is normally air. It is however self-evidently possible for any other desired gaseous media to be used depending on the application.

The thermal energy which is produced during fan operation by the motor and in particular by the winding through which electrical current flows is transmitted by the stator from the interior space to the inner wall of the cooling body. Since the inner wall preferably bears by way of its inner surface directly against the motor, said transmission is particularly efficient. By virtue of the fact that the air-guiding elements conduct the gaseous medium, conveyed by the fan impeller, along the cooling body, the thermal energy can be transmitted from the cooling body to the gaseous medium and can be conveyed from the fan to the outside by said medium. It is normally the case here that the air-guiding elements not only serve for conducting the gas or air flow but simultaneously also have the function of cooling ribs. In general, the air-guiding elements also serve for enlarging the surface area of the cooling body in order to realize an even more efficient transfer of heat to the gaseous medium. Since the air-guiding elements extend in an axial direction over a major part of the longitudinal extent of the winding through which electrical current flows, a good dissipation of heat along the entire longitudinal extent of the motor is achieved.

The outer side of the cooling body is preferably designed such that an efficient transfer of heat to the gaseous medium flowing along the cooling body is achieved, with simultaneously optimum aerodynamics. To as far as possible prevent turbulence of the gaseous medium, the outer side of the cooling body advantageously has, at least in the region of the air-guiding elements, a preferably closed surface which is continuously smooth in the axial direction. The air-guiding elements advantageously extend in each case rectilinearly along the axial direction.

The gaseous medium conveyed by the fan impeller can thus flow through the region of the cavity between the inner wall of the cooling body and outer wall of the housing. Said region of the cavity through which the gaseous medium flows, which can also be referred to as flow chamber preferably forms a ring-shaped chamber which is interrupted at multiple points in the circumferential direction by the air-guiding elements. Owing to the air-guiding elements, it is advantageously the case that a multiplicity of air-guiding ducts is formed which are delimited in the circumferential direction by in each case two air-guiding elements and in a radial direction by the inner wall of the cooling body and by the outer wall of the housing. The air-guiding ducts preferably extend in each case rectilinearly and parallel to the axis of rotation. The air-guiding ducts furthermore advantageously extend over a major part of the longitudinal extent of the cooling body in the axial direction and in particular over a major part of the longitudinal extent, or better even over the entire longitudinal extent, of the motor.

The fan is suitable in particular for applications in which a high pressure or large negative pressure and/or a high throughput of the gaseous medium are required. Such applications relate for example to positioning systems with so-called pick-and-place devices. The fan is used in the case of such appliances in order to grip and move products by way of the generation of a vacuum. The fan may however also be used for example in the handling of paper or textiles. It is also possible for the fan to be used in the ventilation equipment of bioreactors or small sewage plants. A further possible use is in vacuum cleaners and air blades, such as are often used for example in hand dryers. Use of the fan in the case of diesel engines for the purposes of optimizing the diesel combustion (post-combustion) or in fuel cells is also conceivable.

The cooling body is preferably formed as one entire piece and from a material with good thermal conductivity, in particular from metal.

The inner wall of the cooling body advantageously has a hollow cylindrical inner surface, and the motor advantageously has a cylindrical outer surface. It is preferably also the case that the outer wall has a hollow cylindrical inner surface.

The air-guiding elements preferably extend in each case in the axial direction over a major part of the longitudinal extent of the stator, in particular of the stator winding. The winding through which electrical current flows may thus in particular be the stator winding. It is even more preferably the case that the air-guiding elements extend in each case in the axial direction over the entire longitudinal extent of the stator, in particular of the stator winding. It is most preferable for the air-guiding elements to extend in each case in the axial direction even over a major part of the longitudinal extent of the motor, in particular over the entire longitudinal extent of the motor. The air-guiding elements may in each case even extend in the axial direction beyond the overall longitudinal extent of the motor to one or both sides. The thermal energy can thereby be dissipated from the motor in optimum fashion.

The inner wall of the cooling body surrounds the stator advantageously along its entire longitudinal extent. The motor is thus preferably accommodated entirely in the interior space of the cooling body and is in particular surrounded entirely by the inner wall of said cooling body in the circumferential and axial directions, that is to say over the entire longitudinal extent of the motor.

The fan impeller is advantageously designed to convey the drawn-in gaseous medium in a radially outward direction. The fan impeller can then be referred to as a radial compressor. A diversion of the air flow into the axial direction is realized downstream of the fan impeller preferably by way of a lateral delimitation of the air flow by the housing.

In order to divert the gaseous medium that is conveyed by the fan impeller into the axial direction toward the cooling body, it is furthermore preferably the case that a diffuser is provided along the axial direction between the fan impeller and the cooling body. The diffuser advantageously has guide blades which divert the gaseous medium conveyed by the fan impeller such that said gaseous medium flows exclusively in the axial direction and thus no longer has flow components in other directions, in particular in the circumferential direction.

The guide blades of the diffuser advantageously have in each case one end, facing toward the fan impeller, with an edge which tapers to a point. In this way, turbulence of the gaseous medium in the region of the diffuser can be substantially prevented.

It is preferable for each of the air-guiding elements of the cooling body to be assigned in each case one guide blade of the diffuser. To realize optimum aerodynamics, it is advantageously the case here that the air-guiding elements in each case adjoin the guide blades in an axial direction and transition into said guide blades in a flush manner.

The electrically driven motor is preferably a brushless direct-current motor. In a particularly preferred embodiment, the fan has an electric motor such as is disclosed in EP 2 180 581, the content of disclosure of which is hereby integrated entirely into the present description by reference.

For the mounting of the rotor, it is generally the case that at least one bearing is provided which is fastened in a bearing arrangement element. The bearing may be in particular a ball bearing, preferably a preloaded ball bearing. To permit pressure equalization in the direction of the bearing, the bearing arrangement element advantageously has at least one pressure equalization bore. The pressure equalization bore advantageously serves for producing a connection between the interior space of the cooling body, on the one hand, and the region of the cavity between the cooling body and the housing, on the other hand. The pressure equalization bore could basically also be provided in any desired element of the fan other than the bearing arrangement element, as long as said pressure equalization bore can produce said pressure equalization connection between the interior space and the cavity outside the cooling body.

The inner wall of the cooling body advantageously has an outer surface whose diameter decreases continuously in the axial direction with increasing distance from the fan impeller. The flow chamber for the gaseous medium thereby increases in size with increasing distance from the fan impeller, that is to say from the high-pressure region of the fan in the region of the fan impeller toward the low-pressure region in the outlet region of the fan. Here, it is advantageously the case that the diameter of the outer surface of the inner wall decreases continuously in the axial direction with increasing distance from the fan impeller even along substantially the entire longitudinal extent of the inner wall. With such a design of the inner wall, it is possible to realize optimum aerodynamics values.

The outer wall of the housing preferably has a cylindrical inner surface. The outer surface of the outer wall of the housing is likewise preferably of cylindrical form, though may also be rectangular, and in particular square, in cross section.

To prevent turbulence of the gaseous medium, the housing advantageously has an air inlet which, at least over a certain region, widens continuously in the axial direction toward the fan impeller, and/or has an air outlet which, at least over a certain region, narrows in continuous fashion in the axial direction (AR) away from the fan impeller (14). In a region which opens directly to the outside, however, the air inlet and/or the air outlet preferably widen in continuous fashion toward the outside.

The housing, the fan impeller, the diffuser and the cooling body generally together delimit a flow chamber which, during the operation of the fan, is flowed through by the gaseous medium along a main flow direction. In order to realize optimum aerodynamics, it is advantageously the case that said flow chamber, along the main flow direction, in the region of the fan impeller, narrows toward the diffuser and, in the region of the cooling body, widens with increasing distance from the diffuser. The narrowing in the region of the fan impeller and the widening in the region of the cooling body are advantageously each realized in continuous form.

### BRIEF DESCRIPTION OF THE DRAWINGS

Preferred embodiments of the invention will be described below on the basis of the drawings, which serve merely for illustration and which are not to be interpreted as being restrictive. In the drawings:

FIG. 1 shows a perspective view of a fan according to a first embodiment according to the invention;

FIG. 2 shows a perspective view of the fan of FIG. 1, cut open along a central plane;

FIG. 3 shows a frontal view from the front of the air inlet region of the fan of FIG. 1;

FIG. 4 shows a side view of the fan of FIG. 1;

FIG. 5 shows a side view of the fan of FIG. 1 from a viewing angle perpendicular to that in FIG. 4;

FIG. 6 shows a central sectional view, in the plane A-A indicated in FIG. 4, of the fan of FIG. 1;

FIG. 7 shows a central sectional view, in the plane H-H indicated in FIG. 5, of the fan of FIG. 1;

FIG. 8 shows a cross-sectional view, in the plane B-B indicated in FIG. 4, of the fan of FIG. 1;

FIG. 9 shows a cross-sectional view, in the plane C-C indicated in FIG. 4, of the fan of FIG. 1;

FIG. 10 shows a cross-sectional view, in the plane D-D indicated in FIG. 4, of the fan of FIG. 1;

FIG. 11 shows a cross-sectional view, in the plane E-E indicated in FIG. 4, of the fan of FIG. 1;

FIG. 12 shows a cross-sectional view, in the plane F-F indicated in FIG. 4, of the fan of FIG. 1;

FIG. 13 shows a cross-sectional view, in the plane G-G indicated in FIG. 4, of the fan of FIG. 1;

FIG. 14 shows a perspective view of the fan of FIG. 1 without the housing;

FIG. 15 shows a side view of the fan of FIG. 1 without the housing;

FIG. 16 shows a perspective view of the fan of FIG. 1 without the housing, cut open along a central plane;

FIG. 17 shows a perspective view of the fan of FIG. 1 without the housing, fan impeller or fan impeller nut;

FIG. 18 shows a side view of the fan of FIG. 1 without the housing, fan impeller and fan impeller nut;

FIG. 19 shows a frontal view from the rear of the air outlet region of the fan of FIG. 1 without the housing, fan impeller or fan impeller nut,

FIG. 20 shows a central sectional view, in the plane XX-XX indicated in FIG. 21, of the fan of FIG. 1 without the housing;

FIG. 21 shows a frontal view from the front of the air inlet region of the fan of FIG. 1 without the housing;

FIG. 22 shows a frontal view from the front of the air inlet region of the fan of FIG. 1 without the housing, fan impeller or fan impeller nut;

FIG. 23 shows a central sectional view, in the plane XXIII-XXIII indicated in FIG. 22, of the fan of FIG. 1 without the housing, fan impeller or fan impeller nut;

FIG. 24 shows a perspective view of a fan as per a second embodiment according to the invention;

FIG. 25 shows a side view of the fan of FIG. 24;

FIG. 26 shows a frontal view from the front of the air inlet region of the fan of FIG. 24;

FIG. 27 shows a frontal view from the rear of the air outlet region of the fan of FIG. 24; and

FIG. 28 shows a central sectional view of the fan of FIG. 24.

### DESCRIPTION OF PREFERRED EMBODIMENTS

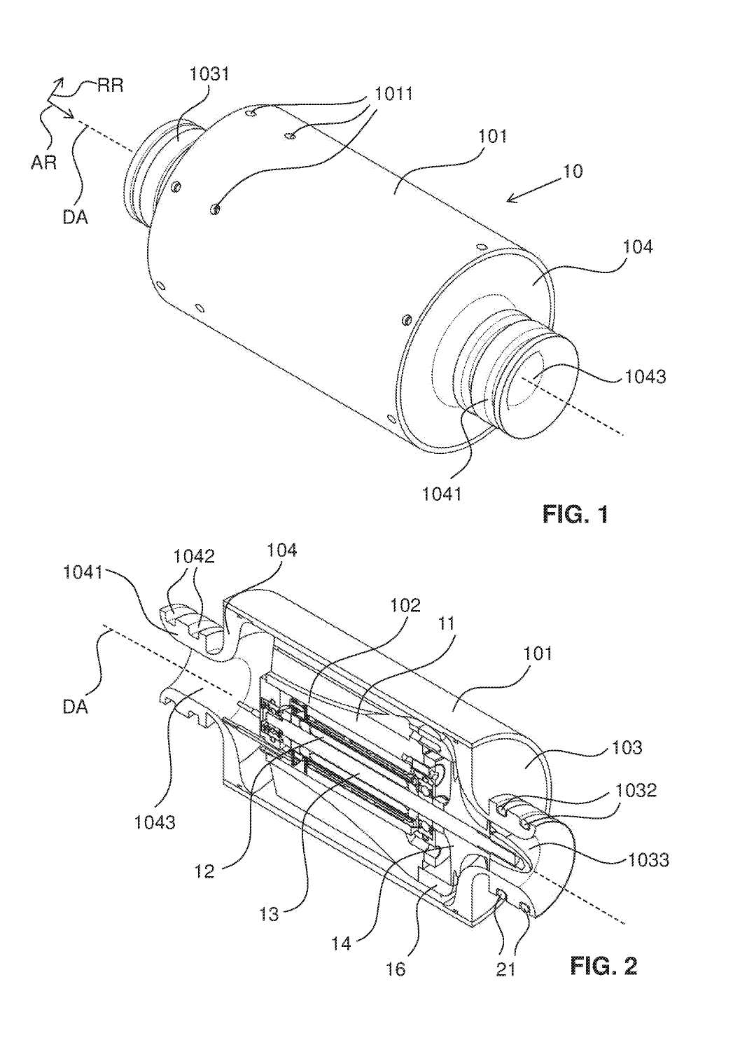

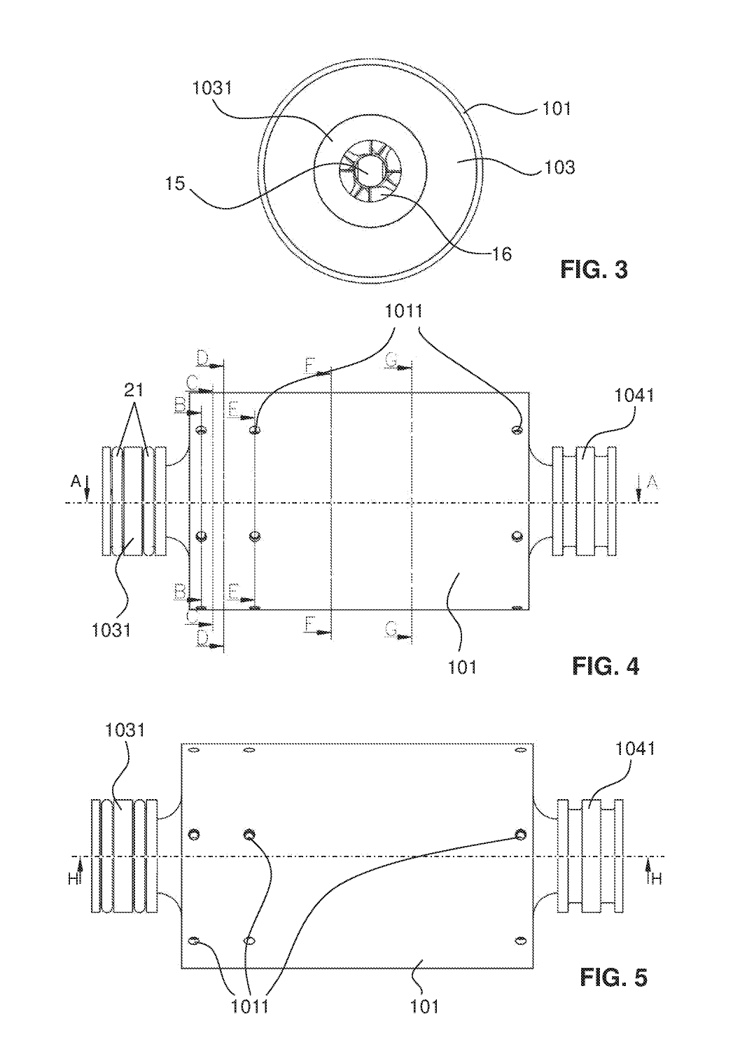

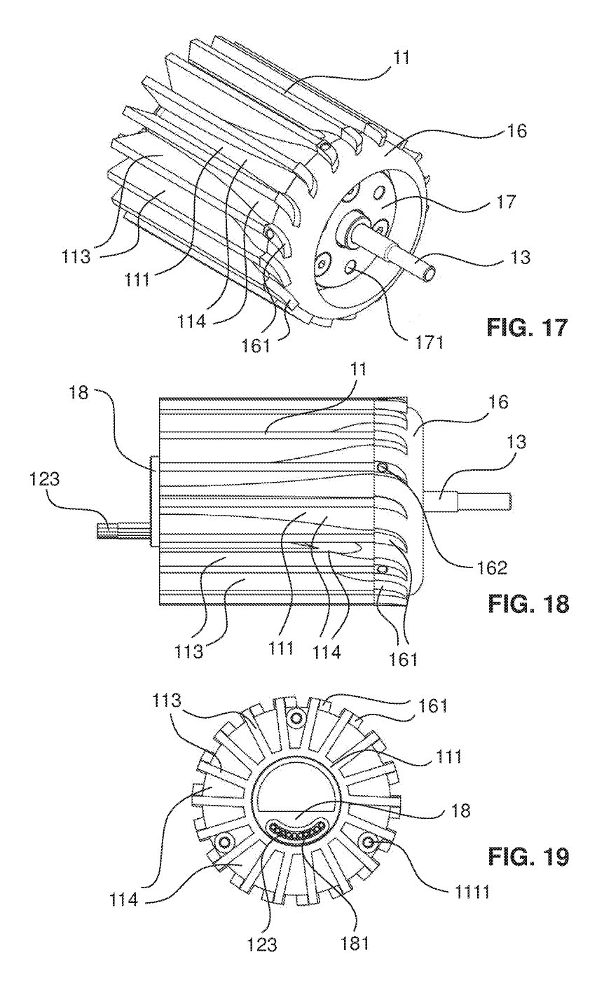

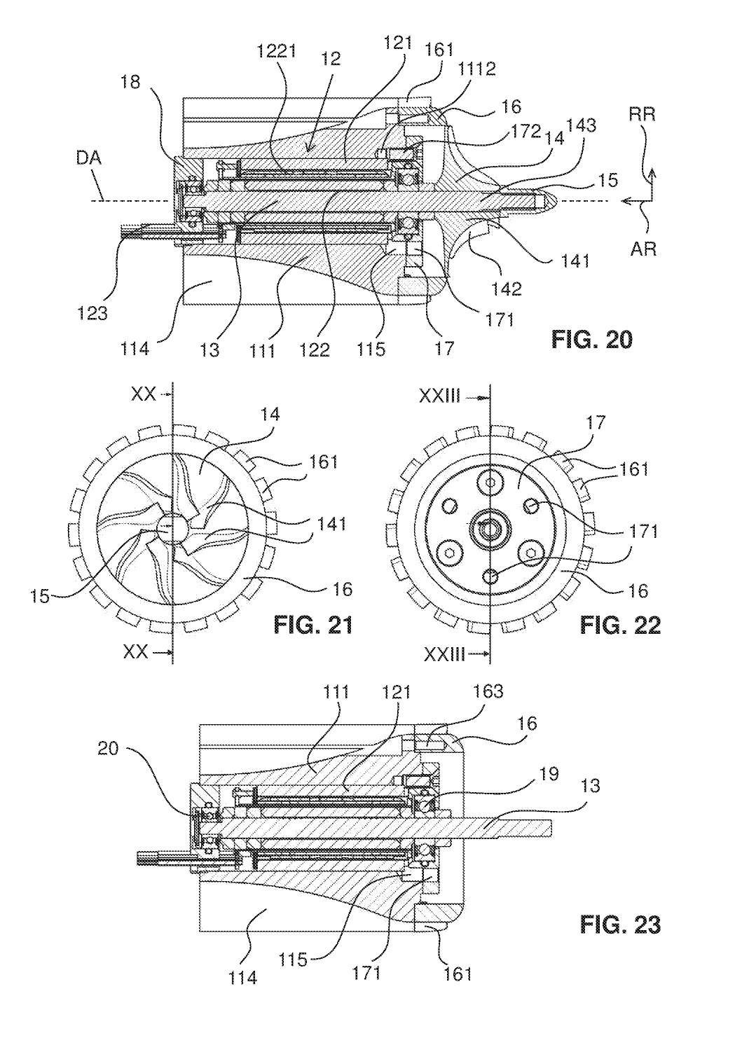

FIGS. 1 to 23 show, in different illustrations, a first embodiment of a fan according to the invention.

As can be clearly seen in FIG. 1, the fan has an altogether very compact form. The fan has a housing 10 which comprises a hollow cylindrical outer wall 101 and an inlet cover 103 and an outlet cover 104 (FIG. 2). The inlet cover 103 and the outlet cover 104 close off the cylinder, which is formed by the outer wall 101, to the outside on both sides.

The inlet cover 103 has a connection piece 1031 which delimits an inlet opening 1033, and the outlet cover 104 has an outlet connector 1041 which delimits an outlet opening 1043. The outer wall 101, the inlet cover 103 and the outlet cover 104 together delimit a cavity 102 of the fan. While the inlet opening 1033 serves for allowing air to flow from the outside into the cavity 102, the outlet opening 1043 serves for allowing the air to flow out of the cavity 102 again to the outside.

With the exception of the inlet opening 1033 and the outlet opening 1043, the cavity 102 is entirely closed off with respect to the outside by the housing 10. The outer wall 101 and the connection pieces 1031 and 1041 are in each case arranged concentrically with respect to an axis of rotation DA of the fan. An axial direction AR and a radial direction RR of the fan are defined on the basis of the axis of rotation DA.

The outer wall 101 of the housing 10 has a number of radial bores 1011 which serve for the screw fixing of the fan components that are arranged in the cavity 102.

The two connection pieces 1031 and 1041 have, in each case on their radially outer side, external grooves 1032 and 1042 respectively into which seal rings 21 can be inserted. The connection pieces 1031 and 1041 can thus serve, depending on the application, for the air-tight connection of further devices, such as for example air hoses or other connection devices of any other design.

The inner surfaces, which face toward the cavity 102, of the inlet cover 103 and of the outlet cover 104 transition, in the axial direction AR, in each case in a flush manner into the inner surface of the outer wall 101. In the region of the inlet cover 103 and of the outlet cover 104, the cavity 102 narrows in each case in continuous fashion in the axial direction AR toward the inlet opening 1033 and toward the outlet opening 1043 as far as the respective connection piece 1031 and 1041 respectively, which has an in each case cylindrical inner surface in the region of the inlet opening 1033 and of the outlet opening 1043 respectively. The inner surfaces of the connection pieces 1031 and 1041 widen in the outward direction in each case at the ends which open to the outside. Owing to these altogether continuous profiles of the inner surfaces of the housing 10, it is possible to realize optimum aerodynamic values.

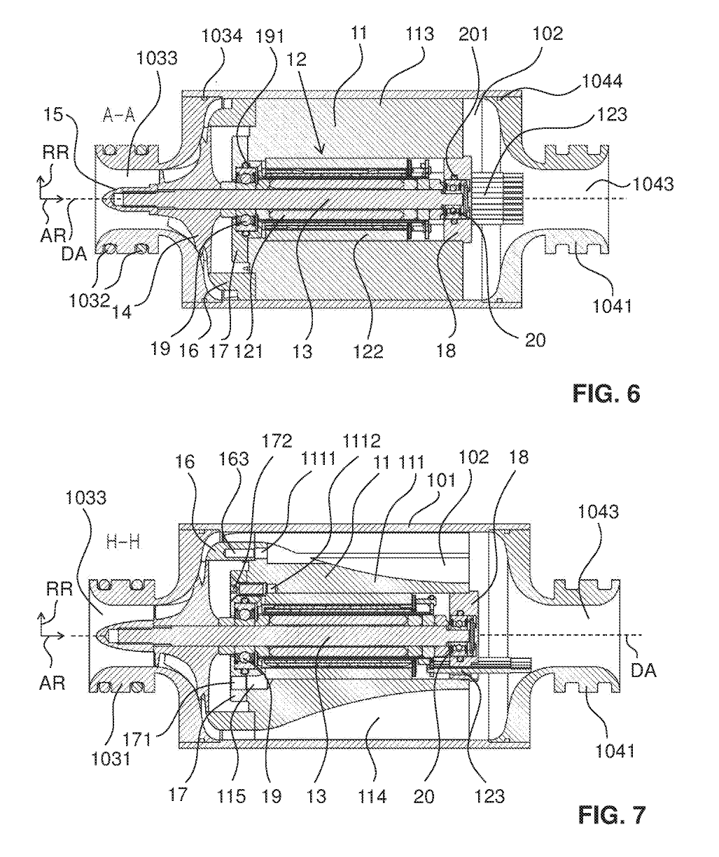

As can be seen for example in FIG. 6, encircling grooves 1034 and 1044 are provided on the outer sides of the inlet cover 103 and of the outlet cover 104, into which grooves there can be inserted in each case one 0-ring. The outer wall 101 can thereby be sealed off with respect to the inlet cover 103 and the outlet cover 104.

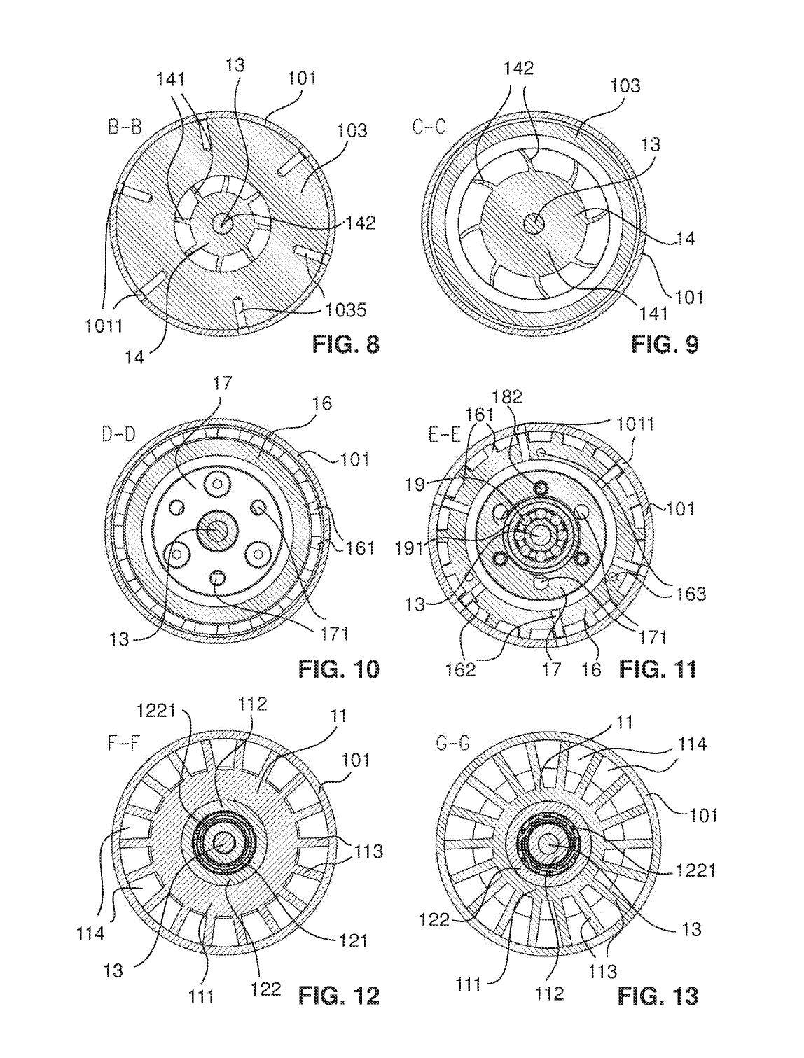

In the inlet cover 103 there are provided radial bores 1035 (FIG. 8) which serve, together with corresponding radial bores 1011 of the outer wall 101, for the screw connection of the inlet cover 103 and of the outer wall 101. Corresponding radial bores are also provided on the outlet cover 104, though these are not visible in the figures.

As can be seen in FIG. 2, a cooling body 11, a motor 12, a drive shaft 13, a fan impeller 14 and a diffuser 16 are arranged, in each case concentrically with respect to the axis of rotation DA, in the cavity 102.

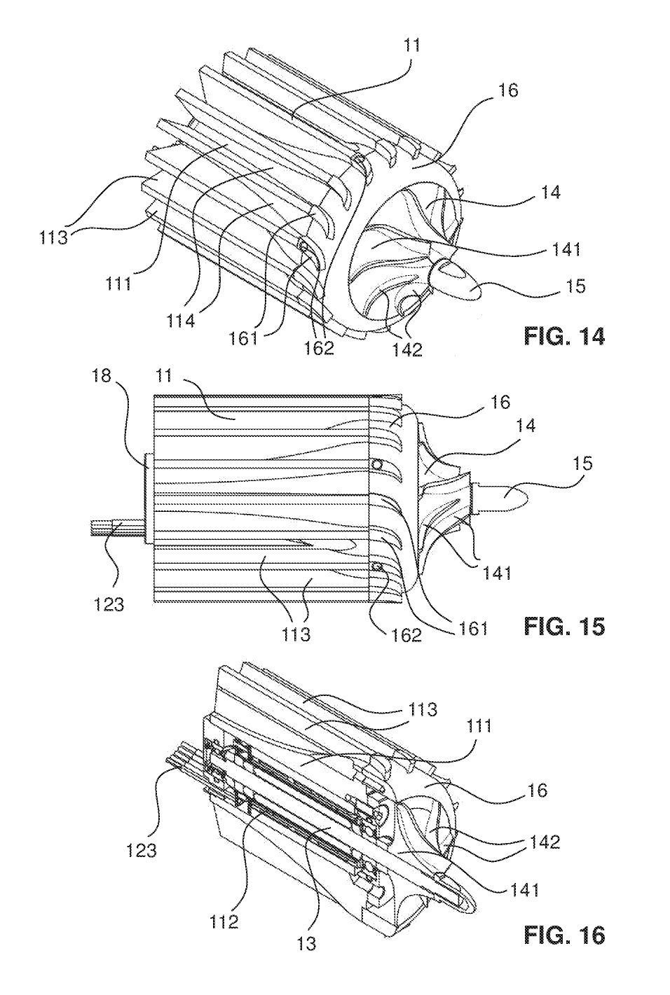

The design of the cooling body 11 can be clearly seen in particular in FIGS. 14 to 19. The cooling body 11 has an inner wall 111 which has a hollow cylindrical inner surface which delimits an interior space 112 of the cooling body 11 in the radial direction RR. The interior space 112 is extended through in the axial direction AR by the drive shaft 13, and serves for accommodating the motor 12.

As can be clearly seen for example in FIG. 7, the wall thickness of the inner wall 111 decreases continuously in the axial direction AR in the direction from the inlet opening 1033 toward the outlet opening 1043. Since the inner surface of the inner wall 111 is of hollow cylindrical form, it is thus the case that the diameter of the outer surface of the inner wall 111 decreases continuously, specifically continuously in the mathematical sense, in the axial direction AR with increasing distance from the inlet opening 1033. The free space of the cavity 102 provided between the outer surface of the inner wall 111 and the inner surface of the outer wall 101, which free space forms a flow chamber for the air flowing through the fan, thus increases in size in the axial direction AR toward the outlet opening 1043.

A multiplicity of rib-like air-guiding elements 133 is formed at regular intervals along the circumferential direction on the outer surface of the inner wall 111, which air-guiding elements extend in each case rectilinearly and parallel to the axis of rotation DA over the entire longitudinal extent of the cooling body 11. Between the air-guiding elements 113 there are provided air-guiding ducts 114 which are in each case delimited to both sides in the circumferential direction by one of the air-guiding elements 113. Owing to the fact that the diameter of the outer surface of the inner wall 111 decreases in the direction of the outlet opening 1043, the air-guiding ducts 114 each have an increasing depth in the same direction.

The air-guiding elements 113 also serve, in particular, as cooling ribs for the transfer of thermal energy from the interior space 112 of the cooling body 11 to the air that flows through the air-guiding ducts 114 in the axial direction AR. The thermal energy generated in the interior space 112 can thus be dissipated to the outside.

The air-guiding ducts 114 are delimited in the radial direction RR in each case by the inner wall 111 of the cooling body 11 and by the outer wall 101 of the housing 10 and in the circumferential direction by in each case two air-guiding elements 113. By virtue of the fact that the air-guiding ducts 114 are thus delimited, along the entire longitudinal extent, only by continuously smooth surfaces, it is possible for a laminar and thus aerodynamically optimum and resistance-free air flow to form in said air-guiding ducts during fan operation.

To ensure an optimum dissipation of heat, the air-guiding elements 113 are advantageously formed in one piece with the inner wall 111 and from the same material as the latter, which exhibits good thermal conductivity. It has been found that optimum aerodynamic values with simultaneously satisfactorily efficient heat dissipation are achieved if the cooling body 11 has between 10 and 26, in particular between 14 and 22, and most preferably, as the case here, exactly 18 air-guiding elements 113, which are arranged at regular intervals along the circumferential direction.

In the radial direction RR, the air-guiding elements 113 bear preferably along their entire longitudinal extent against the inner surface of the outer wall 101, such that heat energy can be transmitted not only to the air flowing through the air-guiding ducts 114 but also to the housing 10 (FIGS. 12 and 13).

As can be seen for example from FIG. 7, the cooling body 11 has, in that face surface of the inner wall 111 which faces toward the inlet opening 1033, first axial bores 1111 for the fastening of the diffuser 16. Furthermore, second axial bores 1112 are likewise provided in that face surface of the inner wall 111 which faces toward the inlet opening 1033. The second axial bores 1112 serve for the fastening of a first bearing shield 17 via axial bores 172 correspondingly provided therein.

The first bearing shield 17 serves, together with a second bearing shield 18 which is arranged on that side of the cooling body 11 which faces toward the outlet opening 1043, for the mounting of a drive shaft 13. The first and the second bearing shield 17 and 18 are thus static, like the housing 10, the cooling body 11 and the diffuser 16. For the mounting of the drive shaft 13, a first ball bearing 19 is mounted in the first bearing shield 17 and a second ball bearing 20 is mounted in the second bearing shield 18. The two ball bearings 19 and 20 are preloaded. Between the first and second bearing shield 17 and 18 respectively and the respective radial outer side of the ball bearings 19 and 20, there is provided in each case one 0-ring 191 and 201 respectively, whereby optimum vibration damping is realized.

To prevent the bearing grease from being forced out of the ball bearings 19 and 20 during fan operation at very high rotational speeds, pressure equalization bores 171 are provided in the first bearing shield 17. The pressure equalization bores 171 correspond to pressure equalization cutouts 115 which are provided in the region of that face surface of the inner wall 111 of the cooling body which faces toward the inlet opening 1033 (FIGS. 22 and 23). The pressure equalization bores 171 form, together with the pressure equalization cutouts 115, a connection between the interior space 112 of the cooling body 11 and that part of the cavity 102 of the housing 10 which surrounds the cooling body 11. Said connection ensures that in each case a substantially identical or at least similar pressure prevails in the axial direction AR on both sides of the ball bearings 19 and 20.

The second bearing shield 18 has a kidney-shaped leadthrough opening 181 through which connection cables 123 of the motor 12 can be led (FIGS. 7 and 19).

A rotor 121 of the motor 12 is mounted rotationally conjointly on the drive shaft 13. Concentrically outside the rotor 121, there is provided a stator 122 with a stator winding 1221. The stator winding 1221 constitutes a winding through which electrical current flows during operation. During fan operation, a major part of the thermal energy that has to be dissipated is produced in the stator winding 1221 and in the adjacent stator regions. The motor 12 is a brushless direct-current motor which is accommodated entirely in the interior space 112 of the cooling body 11. The motor 12 and in particular the stator 122 bear by way of their outer surfaces against the inner surface of the inner wall 111 of the cooling body. An optimum transfer of heat from the motor 12 to the cooling body 11 is realized in this way. Since the air-guiding elements 113 of the cooling body 11 extend in the axial direction AR over the entire longitudinal extent of the motor 12 and in particular of the stator 122 and even beyond, the thermal energy produced in the motor 12 can be dissipated in optimum fashion.

The motor used in the present embodiment is an electric motor as is presented and described in EP 2 180 581. Corresponding to the disclosure of EP 2 180 581, the stator winding 1221 has, in particular, multiple rhombic individual coils which are produced from flat wire and which overlap one another in the manner of roof tiles, as can also be seen from FIG. 13.

At approximately the level of the inlet cover 103 in the axial direction AR, the fan impeller 14 is mounted rotationally conjointly on the drive shaft 13. The fan impeller 14 is of similar design to a compressor wheel of a turbocharger and has a rotationally symmetrical main body with a central through opening 143. The fan impeller 14 may therefore also be referred to as compressor wheel. The inner diameter, which defines the through opening 143, of the main body is only slightly larger than the outer diameter of the drive shaft 13, which projects through the through opening 143. At its end facing toward the inlet opening 1033, the main body 141 has an outer diameter which is only slightly larger than its inner diameter. In the axial direction AR toward the cooling body 11, the outer diameter of the main body 141 however increases in continuous fashion and with an increase similar to an exponential function.

Multiple fan blades 142 are mounted, at regular intervals along the circumferential direction, on the main body 141 on the side facing toward the inlet cover 103. The fan blades 142 serve for conveying the air by virtue of the fan impeller 14 being rotated by the motor 12 and, in this way, air being drawn through the inlet opening 1033 into the cavity 102 and being discharged to the outside again through the outlet opening 1043 via the air-guiding ducts 114.

It is preferable for 6 to 10, or as is the case here exactly 8, fan blades to be provided, which are advantageously formed in one piece with the main body 141. In the frontal view of the air inlet region of the fan from the front in FIG. 21, the fan blades 142 are in each case of S-shaped form and extend, with a slight inclination relative to the radial direction RR, outward from that region of the main body 141 which is adjacent to the drive shaft 13 as far as the peripheral region of the main body 141.

The fan impeller 14 is fastened rotationally conjointly to the drive shaft 13, and thus to the rotor 121, by way of a fan impeller nut 15 which is screwed onto that end of the drive shaft 13 which is arranged in the region of the inlet opening 1022. The fan impeller nut 15 is designed such that its outer surface transitions flush into the outer surface of the main body 141 of the fan impeller 14 in the axial direction AR. Toward the outside in the direction of the inlet opening 1033, the fan impeller nut 15 has an end which tapers to a point.

During a rotation of the fan impeller 14, air is drawn in the axial direction AR through the inlet opening 1033 and is conveyed by the fan blades 142 initially in the axial direction AR toward the cooling body 11 and then in the radial direction RR toward the outside.

A diversion of the air, which is conveyed radially toward the outside by the fan impeller 14, into the axial direction AR is realized owing to the shape of the inner surface of the inlet cover 103 and then owing to the inner surface, which defines the further flow direction, of the outer wall 101.

The diffuser 16 is arranged in the axial direction AR between the fan impeller 14 and the cooling body 11. The diffuser 16 serves for diverting the air, conveyed by the fan impeller 14, into the air-guiding ducts 114 of the cooling body 11. The diffuser 16 thus serves in particular for converting the air flow, which immediately downstream of the fan impeller 14 still has a direction component pointing in the circumferential direction, into an air flow which has a direction component pointing exclusively in the axial direction AR. For this purpose, the diffuser 16 has guide blades 161 which for the purposes of preventing air turbulence have, in the axial direction AR toward the fan impeller 14, an end which tapers in each case to a point. Toward said ends, the guide blades 161 are in each case curved slightly into the circumferential direction counter to the intended direction of rotation of the fan impeller 14. Toward the cooling body 11, the guide blades 161 run in each case so as to be increasingly parallel to the axis of rotation DA.

In order to realize as low an air resistance as possible, each of the air-guiding elements 113 of the cooling body 11 is assigned in each case one guide blade 161 of the diffuser 16, which guide blade bears in the axial direction AR against the corresponding air-guiding element 113 and transitions flush into said air-guiding element on all sides.

The diffuser 16 has a number of radial bores 162 which serve for the screw connection of the diffuser 16 to the outer wall 101 via corresponding radial bores 1011 provided in the outer wall 101 (FIGS. 11 and 15). Furthermore, multiple axial bores 163 are provided in the diffuser 16 for the screw connection of the diffuser 16 via the axial bores 1111 to the cooling body 11 (FIGS. 7 and 11).

During the operation of the fan, it is thus the case that the fan impeller 14 is set in rotational motion about the axis of rotation DA by the motor 12. In this way, air is drawn through the inlet opening 1033 by the fan blades 142 and conveyed to the outside in the axial direction AR and then in the radial direction RR. Owing to the curved form of the inner surface of the inlet cover 103 in the region directly adjacent to the peripheral region of the fan impeller 14, the drawn-in air is diverted into the axial direction AR again. The diffuser 16 is arranged in the region in which the air is diverted from the radial direction into the axial direction. Said diffuser, which is arranged in the high-pressure region of the fan, diverts the air flow, which immediately downstream of the fan impeller 14 still has a direction component pointing in a circumferential direction, into an air flow which flows purely in the axial direction AR. From the diffuser 16, the air is conducted into the air-guiding ducts 114 of the cooling body 11, where a substantially laminar air flow delimited by substantially smooth surfaces can form. As a result of the flow along the inner wall 111 and along the air-guiding elements 113, thermal energy is transferred from the cooling body 11 to the air flowing through the air-guiding ducts 114 and is thus dissipated, whereby extremely efficient motor cooling is effected, with simultaneously optimum aerodynamics. Owing to the decreasing outer diameter of the inner wall 111, the air-guiding ducts 114 increase in depth in the axial direction AR toward the outlet cover 104, which likewise has a positive effect on aerodynamics. The air emerges from the air-guiding ducts 114 in the region of the outlet cover 104. Said region can be referred to as low-pressure region of the fan. Finally, the air passes to the outside again through the outlet opening 1043.

The embodiment shown in FIGS. 1 to 23 may be designed for rotational speeds of up to 150,000 rpm. Here, a differential pressure of 500 mbar or greater may be achieved, wherein the noise measured at this value, and the vibrations generated, are minimal. The fan may however also be designed for rotational speeds of up to 400,000 rpm with a differential pressure of 2000 mbar. The structural size of the fan may, with regard to the outer wall 101, be specified so as to have an outer diameter of 55 mm and a length of 130 mm.

To realize a high air pressure or large negative air pressure even at relatively low rotational speeds, it is possible for multiple fans according to the invention to be arranged one behind the other in series. For a high air throughput, it is possible for multiple fans according to the invention to be arranged in parallel with one another.

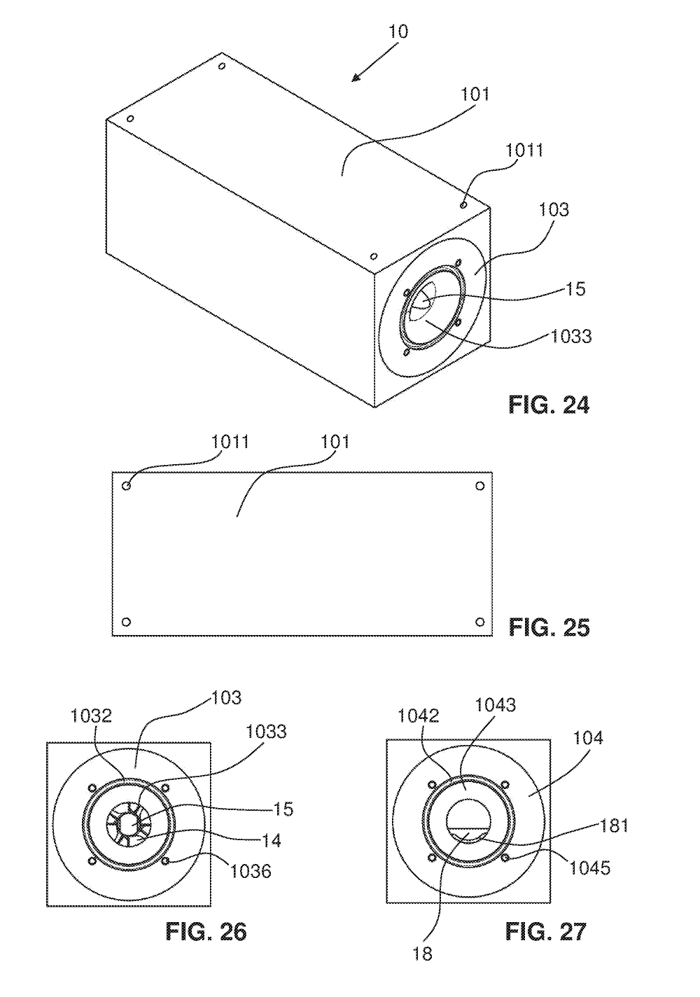

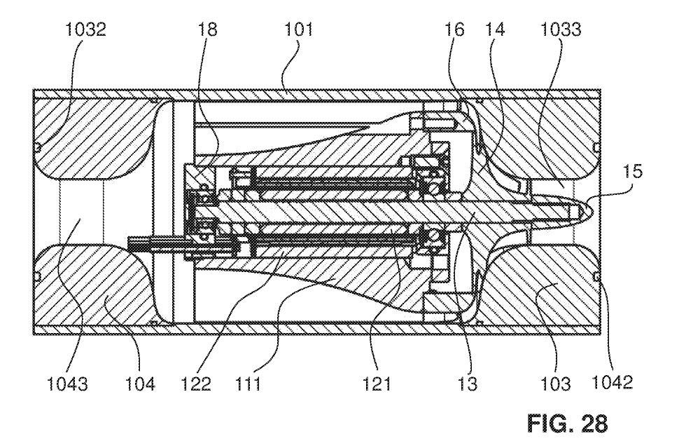

A second embodiment of a fan according to the invention is shown in FIGS. 24 to 28. Elements of the fan which have the same function or a similar function to those in the embodiment shown in FIGS. 1 to 23 are denoted in each case by the same reference designations as in FIGS. 1 to 23.

By contrast to the embodiment shown in FIGS. 1 to 23, the fan in this case has a housing 10 with an outer wall 101 whose outwardly facing outer surface is of square cross section. Since it is also the case in the present embodiment that no connection pieces are provided in the air inlet and air outlet regions, the fan is altogether of cuboidal design. The fan is thus of very compact form and is optimally suitable for modular installation. For the connection of, for example, an air hose to the inlet and/or outlet region of the fan, it is for example possible for in each case one or more internal threads 1036, 1045 to be provided in the region of the inlet opening 1033 and of the outlet opening 1043 respectively. The sealing between the fan and the air hose or some other connection element is realized by way of O-rings which are placed into correspondingly provided external grooves 1032 and 1042 respectively.

The fan impeller 14, diffuser 16, cooling body 11 and motor 12 are advantageously in each case substantially identical to those in the embodiment shown in FIGS. 1 to 23. The outer wall 101 of the housing 10 duly has an outer surface of square cross section. The inner surface of the outer wall 101 is however advantageously of hollow cylindrical form, that is to say of circular cross section. The narrowings of the flow chamber in the regions of the inlet opening 1033 and of the outlet opening 1043 are realized by way of corresponding design of the inlet cover 103 and of the outlet cover 104. Here, both the inlet cover 103 and the outlet cover 104 each have an outer surface of square cross section and a circular inner surface. The inlet cover 103 and the outlet cover 104 are attached to the housing 10 in each case via bores 1011 which are provided in the outer wall 101.

### LIST OF REFERENCE DESIGNATIONS

| | |
|---|---|
| 10 | Housing |
| 101 | Outer wall |
| 1011 | Radial bores |
| 102 | Cavity |
| 103 | Inlet cover |
| 1031 | Connection piece |
| 1032 | External grooves |
| 1033 | Inlet opening |
| 1034 | Groove |
| 1035 | Radial bores |
| 1036 | Internal thread |
| 104 | Outlet cover |
| 1041 | Connection piece |
| 1042 | External grooves |
| 1043 | Outlet opening |
| 1044 | Groove |
| 1045 | Internal thread |
| 11 | Cooling body |
| 111 | Inner wall |
| 1111 | First axial bores |
| 1112 | Second axial bores |
| 112 | Interior space |
| 113 | Air-guiding elements |
| 114 | Air-guiding ducts |
| 115 | Pressure equalization cutout |
| 12 | Motor |
| 121 | Rotor |
| 122 | Stator |
| 1221 | Stator winding |
| 123 | Connection cable |
| 13 | Drive shaft |
| 14 | Fan impeller |
| 141 | Main body |
| 142 | Fan blades |
| 143 | Through opening |
| 15 | Fan impeller nut |
| 16 | Diffuser |
| 161 | Guide blades |
| 162 | Radial bores |
| 163 | Axial bores |
| 17 | First bearing shield |
| 171 | Pressure equalization bores |
| 172 | Axial bores |
| 18 | Second bearing shield |
| 181 | Leadthrough opening |
| 19 | First ball bearing |
| 191 | O-ring |
| 20 | Second ball bearing |
| 201 | O-ring |
| 21 | Seal rings |
| DA | Axis of rotation |
| RR | Radial direction |
| AR | Axial direction |

1. A fan comprising:
an electrically driven motor having a stator and having a rotor which is mounted so as to be rotatable about an axis of rotation, wherein a radial and an axial direction of the fan are defined based on the axis of rotation, and wherein the motor has at least one winding through which an electrical current flows during operation;
a fan impeller which is fastened rotationally conjointly to the rotor and which serves for drawing in and conveying a gaseous medium;
a cooling body having an inner wall which delimits an interior space for accommodating the motor, and having air-guiding elements which extend in each case in the axial direction over a major part of a longitudinal extent of the winding through which electrical current flows, in order to conduct the gaseous medium, which is conveyed by the fan impeller, along the cooling body or cooling the motor; and
a housing having an outer wall which delimits a cavity for accommodating the cooling body and the motor.

2. The fan according to claim 1, wherein the air-guiding elements extend in the axial direction over a major part of the longitudinal extent of the stator.

3. The fan according to claim 1, wherein the inner wall of the cooling body radially surrounds the stator along its entire longitudinal extent.

4. The fan according to claim 1, wherein the air-guiding elements extend in each case rectilinearly along the axial direction.

5. The fan according to claim 1, wherein the fan impeller is designed to convey the drawn-in gaseous medium in a radially outward direction.

6. The fan according to claim 1, wherein a diffuser is provided along the axial direction between the fan impeller and the cooling body in order to divert the gaseous medium, which is conveyed by the fan impeller, into the axial directiontoward the cooling body.

7. The fan according to claim 6, wherein the diffuser has guide blades which have in each case one end, facing toward the fan impeller, with an edge which tapers to a point.

8. The fan according to claim 6, wherein each of the air-guiding elements of the cooling body is assigned a guide blade, and wherein the air-guiding elements in each case adjoin the guide blades in the axial direction and transition into said guide blades in a flush manner.

9. The fan according to claim 1, wherein the electrically driven motor is a brushless direct-current motor.

10. The fan according to claim 1, wherein, for the mounting of the rotor 4, there is provided at least one bearing (19) which is fastened in a bearing arrangement element, and wherein the bearing arrangement element has at least one pressure equalization bore for permitting a pressure equalization in the direction of the bearing.

11. The fan according to claim 1, wherein the inner wall of the cooling body has an outer surface whose diameter decreases continuously in the axial direction with increasing distance from the fan impeller.

12. The fan according to claim 11, wherein the diameter of the outer surface of the inner wall decreases continuously in the axial direction with increasing distance from the fan impeller along substantially an entire longitudinal extent of the inner wall.

13. The fan according to claim 1, wherein the outer wall of the housing has a cylindrical inner surface.

14. The fan according to claim 1, wherein the housing has an air inlet which widens continuously in the axial direction toward the fan impeller and/or has an air outlet which narrows continuously in the axial direction away from the fan impeller.

15. The fan according to claim 1, wherein the housing, the fan impeller, the diffuser and the cooling body together delimit a flow chamber which, during the operation of the fan, is flowed through by the gaseous medium along a main flow direction and which, along the main flow direction, in thea region of the fan impeller, narrows toward the diffuser and, in a region of the cooling body, widens with increasing distance from the diffuser.
